(19) United States
(12) Patent Application Publication
(10) Pub. No.: US 2024/0196489 A1
(43) Pub. Date: Jun. 13, 2024

(54) COOKING APPLIANCE

(71) Applicant: LG ELECTRONICS INC., Seoul (KR)

(72) Inventors: Junghyeong HA, Seoul (KR); Sunghun SIM, Seoul (KR); Hoongoo LEE, Seoul (KR)

(73) Assignee: LG ELECTRONICS INC., Seoul (KR)

(21) Appl. No.: 18/525,602

(22) Filed: Nov. 30, 2023

(30) Foreign Application Priority Data
Dec. 7, 2022 (KR) 10-2022-0169314

(51) Int. Cl. H05B 11/00; H05B 6/10; H05B 6/54

(52) U.S. Cl. CPC H05B 11/00; H05B 6/105; H05B 6/54

(57) ABSTRACT

A cooking appliance can include a housing including a cavity; a door connected to the housing and configured to open and close the cavity; a radio frequency (RF) generator configured to generate RF power for generating electric fields in the cavity; an RF matcher configured to match an impedance of the RF power with a load of the cavity. Also, the cooking appliance can further include a working coil configured to emit magnetic fields toward the cavity.

### CROSS-REFERENCE TO RELATED APPLICATIONS

The present application claims priority under 35 U.S.C. 119 to Korean Patent Application No. 10-2022-0169314 filed in the Republic of Korea on Dec. 7, 2022, the entirety of which is hereby incorporated by reference into the present application.

### BACKGROUND

The present disclosure relates to a cooking appliance. More specifically, the present disclosure relates to a cooking appliance that provides an electrode-type RF heating method and an induction heating method.

Various types of cooking appliances are used to heat food at home or in restaurants. For example, various cooking appliances, such as a microwave oven, an electrode-type radio frequency (RF) oven, and an induction heating-type electric stove, are used.

The microwave oven is a high frequency heating-type cooking appliance, uses a molecule (e.g., H₂O) that vibrates violently and generates heat in a high frequency electric field, and can heat food.

The electrode-type RF oven can heat food using lower frequencies and longer wavelengths than the microwave oven. The electrode-type RF oven can have a capacitive heating structure and can heat an object to be heated, such as food or a container containing food, which is disposed between two electrodes, each of which is made of a metal.

The induction heating-type cooktop is a cooking appliance that heats the object to be heated using electromagnetic induction. Specifically, the induction heating-type cooktop can use magnetic fields generated around a coil when high-frequency power having a predetermined intensity is applied to the coil to generate eddy current in the object to be heated, which is made of a metal, thereby heating a container containing food itself. Thus, the induction heating-type cooktop can heat food by directly heating the container when the container is made of a metal component. When the container is made of a non-metallic component, an intermediate heating element made of a metal component can be heated, and the heat of the intermediate heating element can be transferred to the container to heat the food.

As such, as the cooking appliances using various heat sources are released, there are problems that the number and types of cooking appliances provided to the users have increased, and these cooking appliances occupy a large volume in the living space. Accordingly, there is an increasing demand for users of a multi-purpose cooking appliance including a plurality of heating modules. In addition, it is necessary to develop a cooking appliance that uses a plurality of heating methods simultaneously so that food in the object to be heated is cooked more evenly and quickly.

An example of a cooking appliance according to the related art, which uses multiple heating methods at the same time, can be a cooking appliance capable of simultaneously using the microwave oven and the induction heating-type cooktop. However, in the cooking appliance according to the related art, there can be an inconvenience in requiring a separate structure for shielding microwaves of the microwave oven.

In addition, in the cooking appliance according to the related art, since the microwaves of the microwave oven have a high frequency in a GHz band, a wavelength can be short and be permeated only up to a surface of the food, which has the disadvantage of poor uniform heating performance. There is a method for introducing a turntable to improve the uniform heating performance, but when the turntable is introduced, there is a limitation in that it is difficult to provide induction heating because it is difficult to place the induction heating coil.

### SUMMARY OF THE DISCLOSURE

Embodiments provide a cooking appliance that provides a plurality of heating methods.

Embodiments also provide a cooking appliance that provides a plurality of heating methods to solve a limitation, in which a structure of the cooking appliance becomes complicated.

Embodiments also provide a cooking appliance that provides a plurality of heating methods to solve a limitation that it is difficult to maximize heating efficiency of each heating method in the cooling appliance.

In one embodiment, a cooking appliance includes: a housing having a cavity; a door connected to the housing to open and close the cavity; an RF generator configured to generate radio frequency (RF) power for generating electric fields in the cavity; an RF matcher configured to match an impedance of the RF power with a load of the cavity; and a working coil configured to emit magnetic fields toward the cavity.

At least one hold through which the magnetic fields pass can be defined in a bottom surface of the cavity.

The cooking appliance can further include first and second plates disposed with an object to be heated, which is heated by the electric fields and the magnetic fields, therebetween, in which the second plate can be disposed to be in contact with each of both side surfaces of the cavity.

The second plate can be disposed between the first plate and the bottom surface of the cavity.

The electric fields due to the RF power can be generated between the first and second plates.

The second plate can be made of a material that is heated by the magnetic fields generated in the working coil.

The cooking appliance can further include a support configured to support at least one of the first or second plate at heights different from each other on both the side surfaces of the cavity.

The cooking appliance can further include an elevation module configured to allow at least one of the first plate or the second plate to ascend or descend.

The cooking appliance can further include a sensor configured to sense a height of the object to be heated, in which at least one of the first or second plate can move in a vertical direction based on the height of the object to be heated.

The cooking appliance can further include a convection module configured to supply convection heat to the cavity through one surface of the cavity.

The details of one or more embodiments are set forth in the accompanying drawings and the description below. Other features will be apparent from the description and drawings, and from the claims.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings which are briefly described below.

FIG. 1 is a perspective view of a cooking appliance according to an embodiment of the present disclosure.

FIG. 2 is a view for explaining an induction heating method provided by the cooking appliance according to an embodiment of the present disclosure.

FIG. 3 is a view for explaining a heating method of a microwave oven.

FIG. 4 is a view for explaining an electrode-type RF heating method provided by the cooking appliance according to an embodiment of the present disclosure.

FIG. 5 is a view illustrating a potential between two electrodes used in the electrode-type RF heating.

FIG. 6 is a view for explaining the electrode-type RF heating provided by the cooking appliance according to an embodiment of the present disclosure.

FIG. 7 is an exploded view of the cooking appliance according to an embodiment of the present disclosure.

FIG. 8 is a perspective view of the cooking appliance according to an embodiment of the present disclosure.

FIG. 9 is a front view of the cooking appliance according to an embodiment of the present disclosure.

FIG. 10 is a rear view of the cooking appliance according to an embodiment of the present disclosure.

FIG. 11 is a view illustrating a state in which a second plate of the cooking appliance is adjusted in height according to an embodiment of the present disclosure.

FIG. 12 is a perspective view of the cooking appliance according to an embodiment of the present disclosure.

FIG. 13 is a front view illustrating a configuration in which the cooking appliance is provided with an elevation module according to an embodiment of the present disclosure.

FIG. 14 is a perspective view illustrating the configuration in which the cooking appliance is provided with the elevation module according to an embodiment of the present disclosure.

FIG. 15 is a plan view illustrating the configuration in which the cooking appliance is provided with the elevation module according to an embodiment of the present disclosure.

FIG. 16 is a perspective view of the elevation module provided in the cooking appliance according to an embodiment of the present disclosure.

FIG. 17 is an exploded view of the elevation module provided in the cooking appliance according to an embodiment of the present disclosure.

FIG. 18 is a control block diagram of the cooking appliance according to an embodiment of the present disclosure.

### DETAILED DESCRIPTION OF THE EMBODIMENTS

Hereinafter, preferred embodiments according to the present disclosure will be described in detail with reference to the accompanying drawings. In the drawings, the same reference numerals are used to denote the same or similar elements.

The suffixes “module” and “unit or portion” for components used in the following description are merely provided only for facilitation of preparing this specification, and thus they are not granted a specific meaning or function.

In the following description, “connection” between components includes not only direct connection of the components, but also indirect connection through at least one other component, unless otherwise specified.

The present disclosure intends to provide a complex cooking appliance that provides a plurality of heating methods. Among them, it intends to provide a cooking appliance that provides both an electrode-type RF heating method and an induction heating method.

The features of various embodiments of the present disclosure can be partially or entirely coupled to or combined with each other and can be interlocked and operated in technically various ways, and the embodiments can be carried out independently of or in association with each other.

Hereinafter, a cooking appliance according to an embodiment of the present disclosure will be described.

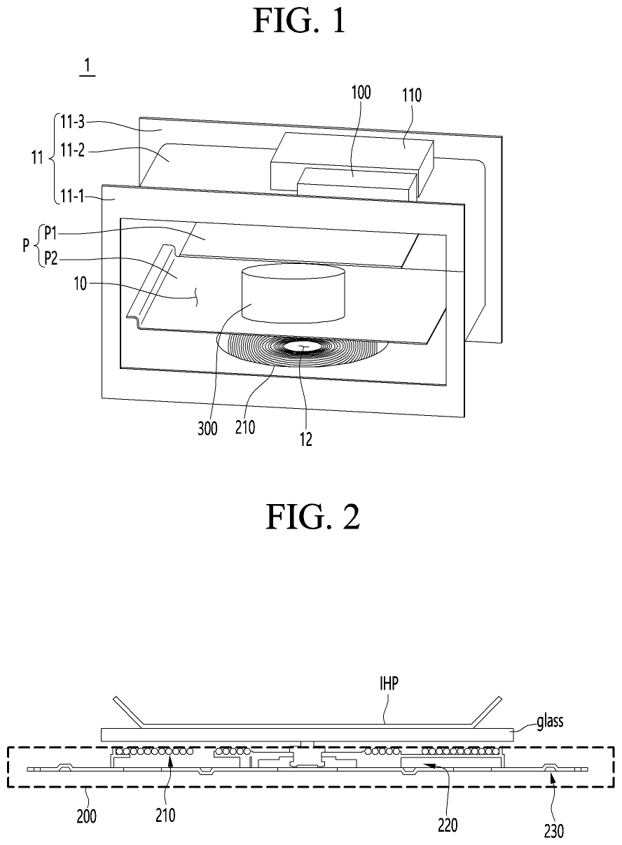

FIG. 1 is a perspective view of a cooking appliance according to an embodiment of the present disclosure.

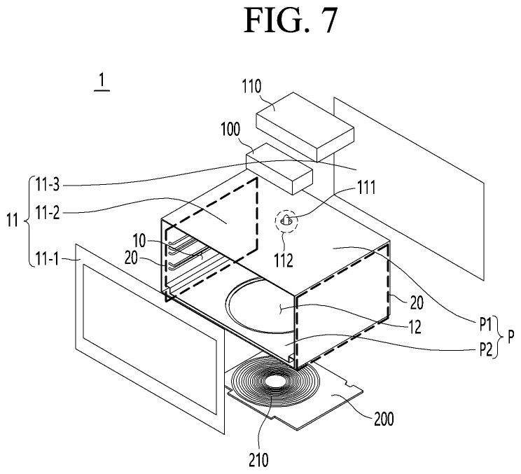

A cooking appliance 1 can include at least some or all of a housing 11, an RF generator 100, an RF matcher 110, a working coil portion 200 (see FIG. 7) including a working coil 210, a door, and a plate P.

The housing 11 can be a case of the cooking appliance 1. A cavity 10 can be defined in the housing 11. The cavity 10 can be a space inside the housing.

The RF generator 100 can generate RF power to generate electric fields within the cavity 10.

The RF matcher 110 can match an impedance of a load of the cavity 10 with the RF power.

The working coil 210 can emit magnetic fields toward the cavity 10 to provide an induction heating method.

The plate P can be provided inside the cavity 10 and can include a first plate P1 and a second plate P2.

The first plate P1 can be connected to the RF generator 100 or the RF matcher 110 disposed on a top surface of an intermediate portion 11-2, which will be described later. The first plate P1 can be used as an electrode for electrode-type RF heating. That is, the first plate P1 can be an electrode member. Specifically, the first plate P1 can be an anode member that functions as an anode of the electrodes.

An object 300 to be heated can be placed on the second plate P2. The second plate P2 can be provided between the first plate P1 and a bottom surface of the cavity 10. In addition, the second plate P2 can be disposed to be in contact with both side surfaces of the cavity 10. The second plate P2 can be used as an electrode for electrode-type RF heating. That is, the second plate P2 can be an electrode member. Specifically, the second plate P2 can be a cathodic member that functions as a cathode of the electrodes. The second plate P2 can be disposed on the working coil 210 and can be made of a material having a magnetic component that is capable of being heated by being combined with the magnetic fields generated by the working coil 210. Thus, the second plate P2 can be used as an electrode for the electrode-type RF heating method and simultaneously can be used as an intermediate heater for the induction heating method. Thus, the object 300 to be heated within the cavity 10 can be heated by the electric fields and magnetic fields.

That is, the cooking appliance 1 according to an embodiment of the present disclosure can provide both the electrode-type RF heating method and the induction heating method.

The plate P can have a plate shape in which the entire plate P is flat and has no void therein. In addition, the plate P can be provided in various shapes such as having a curvature or having a void defined therein. That is, the shape of the plate P is not limited to the shape of the general plate, and thus, the plate P can have any shape capable of accommodating the object to be heated or functioning as the electrode for the RF heating.

Then, each heating method provided by the cooking appliance 1 will be described. The induction heating method will be described first, and the microwave oven provided in the cooking appliance according to the related art will be described, and then, the electrode-type RF heating method will be described.

FIG. 2 is a view for explaining the induction heating method provided by the cooking appliance according to an embodiment of the present disclosure.

Specifically, FIG. 2 is a cross-sectional view of the working coil portion 200, glass, and an IH plate IHP.

The cooking appliance 1 can include all or some of the working coil portion 200, the glass, and the IH plate IHP to provide the induction heating method.

The working coil portion 200 can include all or some of the working coil 210 that generates the magnetic fields, a working coil bracket 220 on which the working coil is placed, and a shield bracket 230 that protects the working coil 210 from the outside.

The working coil 210 can emit the magnetic fields toward the cavity 10 to provide the induction heating method. The magnetic fields emitted from the working coil 210 can be combined with the IH plate IHP to heat the IH plate IHP. For this, the IH plate IHP can be made of a metal material with a magnetic component. Although one working coil 210 is illustrated in FIG. 2, a plurality of working coils 210 can be provided. When the plurality of working coils 210 are provided, there is an advantage in that a plurality of foods are heated at the same time.

An object 300 to be heated such as food or a container containing the food can be placed on the IH plate IHP. The IH plate IHP can be the second plate P2 in FIG. 1. Thus, the magnetic fields emitted from the working coil 210 can be combined with the second plate P2 to heat the second plate P2. For this, the second plate P2 can be made of a metal material with a magnetic component.

In details of the IH plate IHP, the IH plate IHP can be a metal having a magnetic component to be heated by being combined with the magnetic fields. That is, the IH plate IHP can be a magnetic material. When the container is the magnetic material, the container can be heated by being directly combined with the magnetic fields generated from the working coil 210. On the other hand, when the container is a non-magnetic material, or food is placed directly on the IH plate IHP, the IH plate IHP can be combined with the magnetic fields and then heated, and thus, the heat of the IH plate IHP can be transferred to the container or food to heat the container or food. That is, the IH plate IHP can be used as an intermediate heating element.

The glass can be disposed between the working coil 210 and the IH plate IHP to protect the working coil 210 from the heat transferred from the IH plate IHP. The glass can be omitted depending on the embodiment.

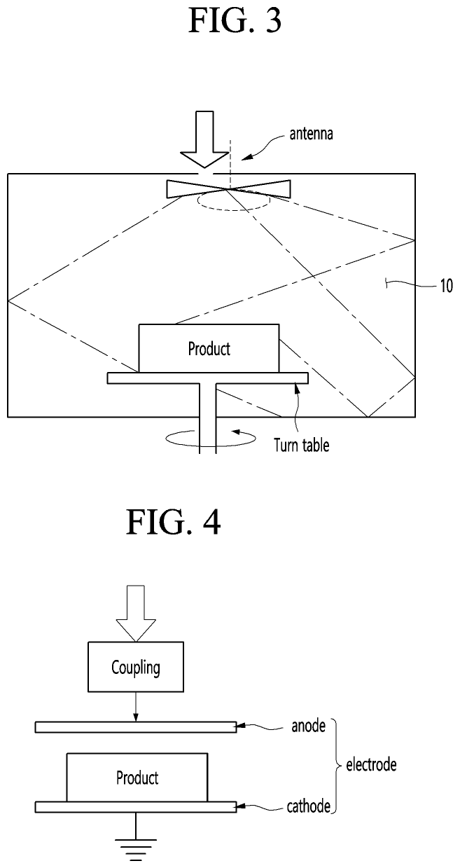

FIG. 3 is a view for explaining a heating method of the microwave oven.

The microwave oven can provide radiant heating that heats food inside the cavity 10 by emitting electromagnetic waves. The radiant heating can emit radio waves into the cavity 10 through an antenna or slot, and the emitted radio waves can be reflected inside the cavity 10 to heat the object 300 to be heated. Thus, a frequency of the radio waves emitted by the microwave oven or a heating mode of the microwave oven can vary depending on a width, height, depth, or volume of the cavity 10 of the microwave oven.

The frequency of the radio waves of the microwave oven can be in an ISM band of about 2.4 GHz to about 2.5 GHz. The lower the frequency of the radio waves and the longer the wavelength, the deeper the radio waves are permeated into the object 300 to be heated to improve uniform heating performance. However, to use the low frequency, the volume of the cavity 10 can need to be designed to be large. When the volume of the cavity 10 of the microwave oven is designed to be too large to improve the uniform heating performance, there is a limitation that it is difficult to place the container or food in the cooking space.

There is a method for maintaining the uniform heating performance without lowering the frequency below about 2.4 GHz by introducing a turn table to rotate the object 300 to be heated during the heating. However, when it is desired to provide the induction heating method using the working coil 210, the working coil 210 has to be disposed vertically below the container containing the food, and thus, it is structurally difficult to introduce the turn table.

In addition, when a hole 12 is defined in the cavity 10 to allow the magnetic fields generated by the working coil 210 to pass therethrough, there is a limitation that a complex electromagnetic wave shielding structure is required.

Thus, the cooking appliance 1 according to an embodiment of the present disclosure can provide the electrode-type RF heating method, rather than the radiant heating method such as the microwave oven to heat the object 300 to be heated together with the induction heating method.

Next, the electrode-type RF heating method provided by the cooking appliance 1 according to an embodiment of the present disclosure will be described.

FIG. 4 is a view for explaining the electrode-type RF heating method provided by the cooking appliance according to an embodiment of the present disclosure.

The cooking appliance 1 can include an electrode to provide the electrode-type RF heating method. The electrode can include an anode and a cathode. The anode can be the first plate P1 of FIG. 1. In addition, the cathode can be the second plate P2 in FIG. 1.

The electric fields can be generated between the anode and cathode. That is, the electric fields can be generated between the first plate P1 and the second plate P2. Thus, the object 300 to be heated, which is placed on the second plate P2, can be heated by the electric fields.

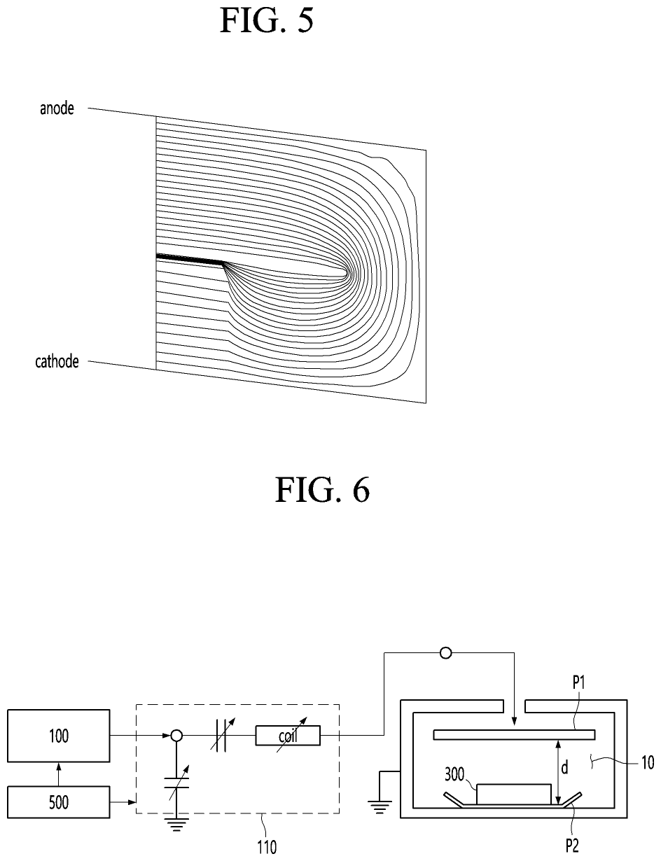

FIG. 5 is a view illustrating a potential between the two electrodes used in the electrode-type RF heating.

Referring to FIG. 5, it is seen that an equipotential surface is provided between the anode and the cathode. The equipotential surface can be a surface that appears when points having the same potential are connected to each other within the electric fields and can be formed mainly in a horizontal direction between the anode and cathode. Through this, when the object 300 to be heated is placed between the two electrodes, it is seen to be uniformly heated from the inside.

In addition, the equipotential surface can be formed close to a horizontal length of the anode and cathode. Thus, since the cooking appliance 1 does not need to adjust the volume of the cavity 10 according to the frequency, when providing the electrode-type RF heating, the object 300 to be heated can be heated using the radio waves having the lower frequency than the frequency of the radio waves emitted by the microwave oven without increasing in volume of the cavity 10. For example, in the electrode-type RF heating method, food can be heated using radio waves having a frequency of about 13.56 MHZ, about 27.12 MHz, or about 40.68 MHz.

Thus, the wavelength of the radio waves emitted by the cooking appliance 1 can be longer than the wavelength of the radio waves emitted by the microwave oven to improve the uniform heating performance. In addition, since the electrode-type RF heating uses the radio waves having a wavelength longer than that of the microwave oven, there is an advantage of not requiring a complex electromagnetic wave shielding structure like the microwave oven.

In addition, since the cooking appliance 1 has fewer frequency restrictions than the microwave oven when providing the electrode-type RF heating, it can also be possible to heat the object 300 to be heated using a resonance frequency at which power efficiency is maximized.

In summary, the cooking appliance 1 according to an embodiment of the present disclosure can uniformly heat the object 300 to be heated by providing the electrode-type RF heating and also can more uniformly heat the object 300 to be heated by using the radio waves having the frequency lower than that of the microwave oven without adjusting the volume of the cavity 10. Since the radio waves having long wavelengths is used, it may not have the complicated electromagnetic wave shielding structure. In addition, since the radio waves having the resonant frequency is used, the power efficiency can be maximized.

FIG. 6 is a view for explaining the electrode-type RF heating provided by the cooking appliance according to an embodiment of the present disclosure.

To provide the electrode-type RF heating, the cooking appliance 1 can include at least some or all of an RF generator 100 that generates RF power to heat the object 300 to be heated, an RF matcher 110 that adjusts an impedance of the RF power, a controller 500, a first plate P1, and a second plate P2.

The RF generator 100 can generate the RF power to emit electric fields toward the cavity 10 to provide the electrode-type RF heating method. The electric fields can be generated between the first plate P1 and the second plate P2 by the RF power. For this, each of the first plate P1 and the second plate P2 can be made of a metal material. In addition, the second plate P2 can be placed to be in contact with both side surfaces of the cavity 10 and then be grounded.

The RF matcher 110 can match an impedance of a load of the cavity 10 with the RF power. The load of the cavity 10 may not be constant and can vary depending on a distance between the electrodes or a state of the object 300 to be heated. The power efficiency can be maximized when the impedance of the load of the cavity 10 and the RF power are the same. Thus, the RF matcher 110 can maximize the power efficiency by matching the impedance of the load of the cavity 10 and the RF power. For example, when the impedance of the RF power is about 50Ω, the RF matcher 110 can match the load of the cavity 10 to about 50Ω.

The controller 500 can control an overall operation of the electrode-type RF heating. For example, the controller 500 can cause the RF generator 100 to generate the RF power. In addition, the controller 500 can control the RF matcher 110 to match the impedance of the load of the cavity 10 with the RF power.

The first plate P1 can serve as an anode of the electrodes used during the electrode-type RF heating. In addition, the second plate P2 can serve as a cathode of the electrodes used during the electrode-type RF heating. Thus, the object 300 to be heated can be heated by the electric fields generated between the first plate P1 and the second plate P2.

As described in FIGS. 2 to 6, the cooking appliance 1 according to an embodiment of the present disclosure can provide the electrode-type RF heating that uniformly heats food from the inside and induction heating that heats food from the bottom at the same time to reduce the cooking time and save energy consumed in the cooking.

In addition, the second plate P2 can be used as an intermediate heater when providing the induction heating and can be used as an electrode when providing the electrode-type RF heating. Thus, the cooking appliance 1 according to an embodiment of the present disclosure has an advantage of having a simple structure while providing a plurality of heating sources.

Next, the cooking appliance 1 according to an embodiment of the present disclosure will be described in more detail.

FIG. 7 is an exploded view of the cooking appliance according to an embodiment of the present disclosure.

As described in FIG. 1, the cooking appliance 1 can include at least some or all of the housing 11, a door, a plate P including the first plate P1 and the second plate P2, the RF generator 100, the RF matcher 110, and the working coil portion 200.

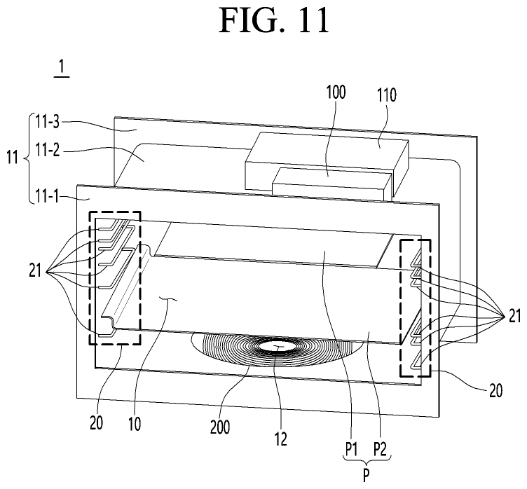

In addition, the cooking appliance 1 can further include a supporter 20. The supporter 20 will be described later with reference to FIG. 11.

The housing 11 can be divided into a front portion 11-1, an intermediate portion 11-2, and a rear portion 11-3.

The front portion 11-1 can define a front surface of the cavity 10. The front portion 11-1 can have a rectangular shape, and a window can be provided so that the inside of the cooking appliance 1 is seen from the outside. Thus, when the door having a window, the front portion 11-1 having a window, and the door having a window are coupled to each other, the inside of the cooking appliance 1 can be seen from the outside even though the door is closed.

The intermediate portion 11-2 can have a rectangular parallelepiped shape with front and rear opened. The intermediate portion 11-2 can define the top surface, the bottom surface, and both the side surfaces of the cavity 10.

A hole 12 through which the magnetic fields generated by the working coil 210 passes can be defined in the bottom surface of the intermediate portion 11-2. That is, at least one hole 12 through which the magnetic fields passes can be defined in the bottom surface of the cavity 10.

A first plate connection hole 112 can be defined in a top surface of the intermediate portion 11-2 to connect the RF matcher 110 to the first plate P1. The first plate connection member 111 can connect the RF matcher 110 to the first plate P1 through the first plate connection hole 112.

Thus, the RF power generated by the RF generator 100 can be transmitted to the RF matcher 110, and the RF matcher 110 can transmit the received RF power to the first plate P1. Thus, the electric fields can be generated between the first plate P1 and the second plate P2.

The rear portion 11-3 can have the same rectangular shape as the front portion 11-1 and can define a rear surface of the cavity 10.

That is, the front portion 11-1, the intermediate portion 11-2, and the rear portion 11-3 of the housing 11 can define the cavity 10 in the rectangular parallelepiped shape.

The RF generator 100 and the RF matcher 110 for the electrode-type RF heating can be disposed on a top surface of the intermediate portion 11-2. In addition, the working coil portion 200 for the induction heating can be disposed under a bottom surface of the intermediate portion 11-2. Thus, a space inside the cavity 10 can be used efficiently, and the RF generator 100, the RF matcher 110, and the working coil portion 200 can be protected from the heat generation when the object 300 to be heated is heated.

For this, a vertical length of the intermediate portion 11-2 of the housing 11 can be shorter than a vertical length of each of the front portion 11-1 and the rear portion 11-3. Specifically, the sum of a vertical length of the intermediate portion 11-2, a vertical length of the RF generator 100 or the RF matcher 110, and a vertical length of the working coil portion 200 including the working coil 210 can be less than the vertical length of the front portion 11-1 or the vertical length of the rear portion 11-2.

The door can be connected to the housing 11. When the door is opened, food can move from the inside to the outside of the cavity 10 or from the outside to the inside. In addition, while the object 300 to be heated is being heated inside the cavity 10, safety can be ensured by separating the cavity 10 from the outside in a state of closing the door.

Since the electric fields are generated within the cavity 10 by the RF generator 100, the housing 11 (see FIG. 1) can be made of a non-permeable material such as STS340 or aluminum to prevent the electric fields from leaking outside the cavity 10. In addition, the housing 11 can be made of a metal component to electrically contact the second plate P2 and ground the second plate P2. In addition, the housing 11 can be made of a non-magnetic material so as not to be heated by the magnetic fields emitted from the working coil 210.

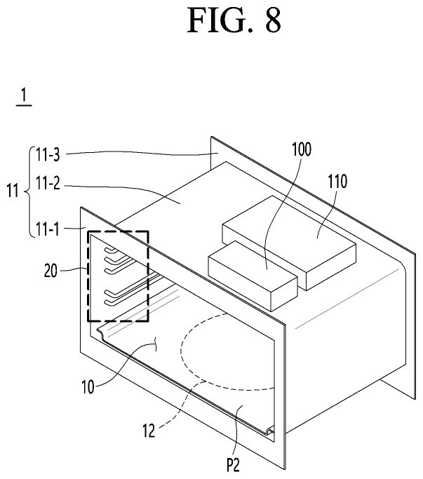

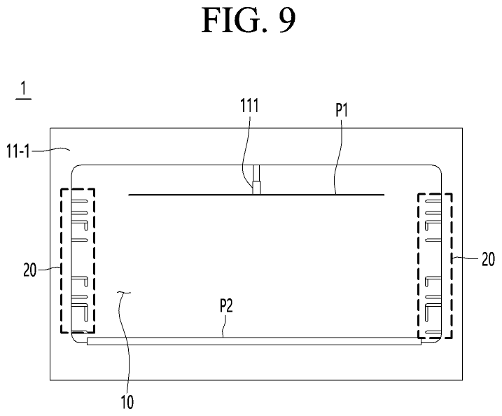

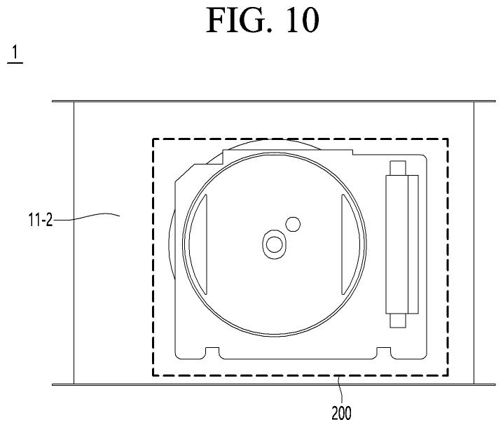

FIG. 8 is a perspective view of the cooking appliance according to an embodiment of the present disclosure. FIG. 9 is a front view of the cooking appliance according to an embodiment of the present disclosure. FIG. 10 is a rear view of the cooking appliance according to an embodiment of the present disclosure.

Specifically, FIGS. 8 and 9 are diagrams illustrating the second plate P2 of the cooking appliance 1 provided on the bottom surface of the cavity 10. FIG. 10 is a view illustrating the working coil portion 200 provided below the lower surface of the intermediate portion 11-2 of the housing.

Referring to FIGS. 8 to 10, the second plate P2 can be provided on the bottom surface of the intermediate portion 11-2 of the housing 11 as illustrated in FIGS. 8 to 9. That is, the second plate P2 may not be supported by the supporter 20 but can be supported on the bottom surface of the cavity 10.

In addition, as described above, at least one hole 12 can be defined in the bottom surface of the intermediate portion 11-2 of the housing 11. That is, at least one hole through which the magnetic fields generated by the working coil 210 passes can be defined in the bottom surface of the cavity 10.

A diameter of the hole 12 can be provided to be larger than that of the working coil 210 by a predetermined length, and thus, the magnetic fields generated from the working coil 210 can pass smoothly. For example, the diameter of the hole 12 can be about 30 Φ to about 40 Φ, which are longer than that of the working coil 210.

In addition, a plurality of holes 12 can be defined to maximize an amount of magnetic fields passing through the holes 12 of the magnetic fields generated in the working coil 210 according to the number and shape of the working coils 210 and also can be defined to have a shape other than a circle.

In summary, the cooking appliance 1 according to an embodiment of the present disclosure can minimize the distance between the working coil portion 200 and the second plate P2 and maximizes the induction heating efficiency by providing the hole 12.

The hole 12 can be filled with a material that does not allow foreign substances to pass therethrough, but allows the magnetic fields to pass therethrough. For example, the hole 12 can be filled with a material such as glass in FIG. 2. Thus, it is possible to prevent a limitation in which the foreign substances, such as food, from falling on the working coil portion 200 through the hole 12 defined in the bottom surface of the cavity 10 to cause a malfunction.

Alternatively, the hole 12 can be filled with a material that allows the magnetic fields to pass therethrough, but does not allow the electric fields to pass therethrough. For example, the hole 12 can be filled with graphite paper. Thus, the magnetic fields can pass through the hole 12 defined in the bottom surface of the cavity 10 to heat the object 300 to be heated, and simultaneously, the electric fields can be shielded to ensure the safety.

The electrode-type RF heating can be more efficient as the distance between the electrodes decreases. That is, the closer the distance between the first plate P1 and the second plate P2, the better the heating efficiency. Thus, the cooking appliance 1 according to an embodiment of the present disclosure can be designed to adjust the distance between the first plate P1 and the second plate P2 to maximize the heating efficiency. For example, the cooking appliance 1 can adjust the distance between the first plate P1 and the second plate P2 through the supporter 20, which will be described in detail below.

FIG. 11 is a view illustrating a state in which the second plate of the cooking appliance is adjusted in height according to an embodiment of the present disclosure.

The supporter 20 can be provided on both the side surfaces of the intermediate portion 11-2 of the housing 11 to support the second plate P2 at different heights. The supporter 20 can include a plurality of support members 21 having different heights. The plurality of support members 21 can have a wire rack shape as illustrated in the drawings. Alternatively, grooves or recesses can be defined in the supporter 20 to support the second plate P2 on both side surfaces. That is, the supporter 20 can have various shapes capable of supporting the second plate P2.

A height of the second plate P2 can be adjusted depending on a height of the support member supporting the second plate P2. In addition, as the height of the second plate P2 is adjusted, the distance between the first plate P1 and the second plate P2 can be adjusted.

The closer the distance between the electrodes, the greater intensity of the magnetic fields between the electrodes can be generated with the same power. That is, the smaller the distance between the first plate P1 and the second plate P2, the higher the electrode-type RF heating efficiency can be.

In addition, the supporter 20 can be made of the same material as the second plate P2 or a material capable of making electrical contact, and thus, the second plate P2 can be electrically grounded to both the side surfaces of the intermediate portion 11-2 through the supporter 20. Thus, the second plate P2 can function as a cathode even when supported by the supporter 20. Additionally, the supporter 20 can function as a cathode together with the second plate P2.

Thus, the cooking appliance 1 according to an embodiment of the present disclosure can provide the electrode-type RF heating even if it further includes the supporter 20. In addition, since the height of the second plate P2 is adjusted using the supporter 20, the efficiency of the electrode-type RF heating can be maximized.

In FIG. 11, it is explained that the height of the second plate P2 is adjusted using the supporter 20, but depending on the embodiment, it is also possible to adjust the height of the first plate P1 using the supporter 20.

As the height of the second plate P2 is adjusted, the distance between the second plate P2 and the working coil portion 200 increases to deteriorate the induction heating efficiency.

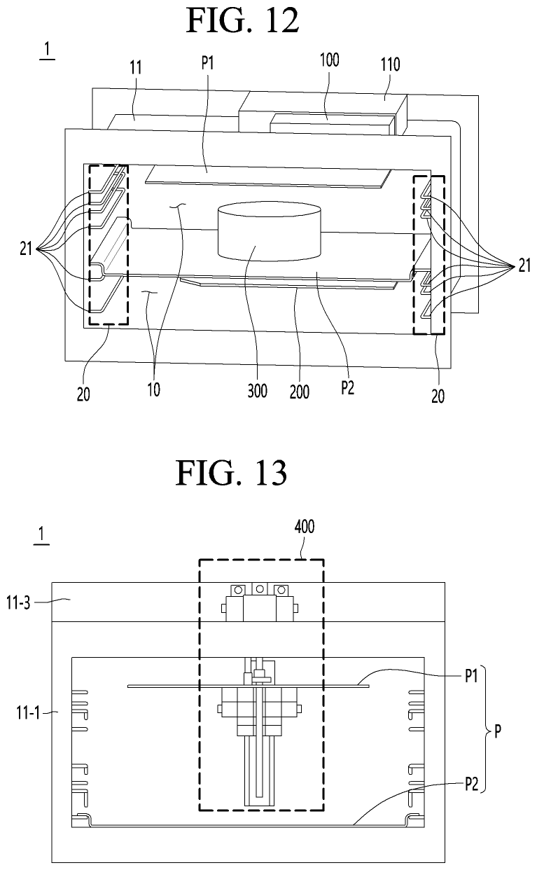

Thus, an embodiment of the present disclosure can provide the cooking appliance 1 in which the distance between the second plate P2 and the working coil portion 200 is constant even if the height of the second plate P2 is adjusted. In relation to this, it will be described in detail with reference to FIG. 12.

FIG. 12 is a perspective view of the cooking appliance according to an embodiment of the present disclosure.

Referring to FIG. 12, the working coil portion 200 can be fixed below the second plate P2. That is, the working coil portion 200 can be provided at a lower portion of the second plate P2. Thus, the working coil 210 included in the working coil portion 200 can be provided at the lower portion of the second plate P2.

As the working coil portion 200 is fixed below the second plate P2, the working coil portion 200 can be disposed between the second plate P2 and the bottom surface of the cavity 10. The bottom surface of the cavity 10 can be a bottom surface of the intermediate portion 11-2 of the housing. That is, the working coil portion 200 can be disposed inside the cavity 10 between the second plate P2 and the bottom surface of the intermediate portion 11-2 of the housing.

The working coil 210 included in the working coil portion 200 can also be disposed between the second plate P2 and the bottom surface of the cavity 10. That is, the working coil portion 200 can be disposed inside the cavity 10 between the second plate P2 and the bottom surface of the intermediate portion 11-2 of the housing.

As the working coil 200 is provided below the second plate P2, when the height of the second plate P2 is adjusted, the height of the working coil 200 can also be adjusted. Thus, even if the height of the second plate P2 is adjusted, the distance between the second plate P2 and the working coil 210 can be maintained.

Thus, the cooking appliance 1 according to an embodiment of the present disclosure can have an advantage that the efficiency of induction heating is not deteriorated because the working coil 200 moves together with the second plate P2 even if the second plate P2 is placed close to the first plate P1 to maximize the efficiency of the electrode-type RF heating.

In addition, the working coil 210 can be disposed between the second plate P2 and the bottom surface of the intermediate portion 11-2 of the housing 11, and thus, the hole 12 through which the magnetic fields pass may not be defined in the bottom surface of the intermediate portion 11-2. Thus, there is a manufacturing advantage in that the process of forming the hole 12 in the housing 11 is omitted.

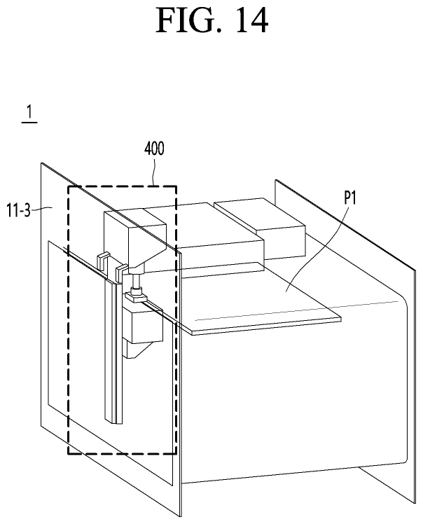

The cooking appliance 1 according to an embodiment of the present disclosure can adjust the distance between the first plate P1 and the second plate P2 by adjusting the height of the first plate P1. For this, the cooking appliance 1 can further include an elevation module 400 (e.g., an elevation part or height adjusting device). In relation to this, it will be described in detail with reference to FIGS. 13 and 14.

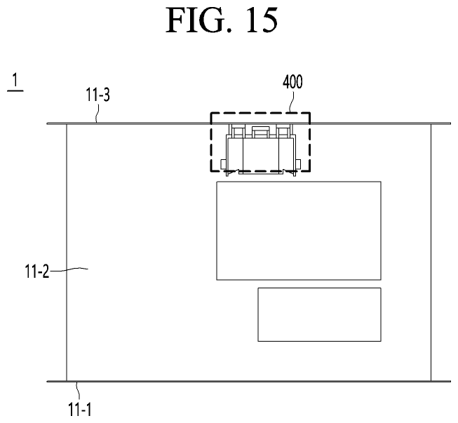

FIG. 13 is a front view illustrating a configuration in which the cooking appliance is provided with an elevation module according to an embodiment of the present disclosure. FIG. 14 is a perspective view illustrating the configuration in which the cooking appliance is provided with the elevation module according to an embodiment of the present disclosure. FIG. 15 is a plan view illustrating the configuration in which the cooking appliance is provided with the elevation module according to an embodiment of the present disclosure.

Referring to FIGS. 13 to 15, an elevation module 400 can be fixed to the rear portion 11-3 of the housing 11.

In addition, a portion of the elevation module 400 can be disposed outside the cavity 10, and a remaining portion can be disposed inside the cavity 10.

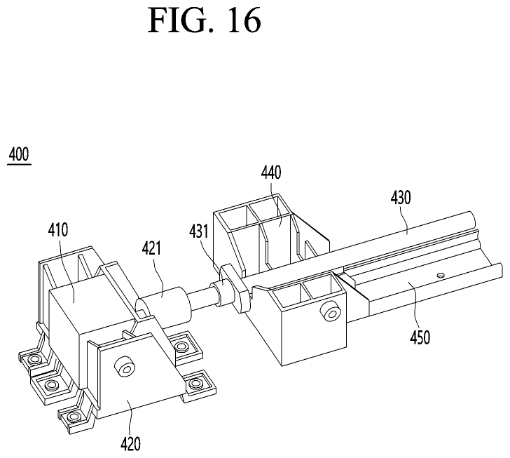

For example, a motor 410 (see FIG. 16) driven to adjust the height of the first plate P1 of the elevation module 400 can be placed outside the cavity 10. The motor 410 (see FIG. 16) can be placed higher than the top surface of the intermediate portion 11-2 of the housing 11. Thus, a space inside the cavity 10 can be saved, and the motor 410 (see FIG. 16) can be protected from the heat generation when the object 300 to be heated is heated.

A plate coupling portion 440 (see FIG. 16) that moves the first plate P1 in the vertical direction and a rail 450 (see FIG. 16) on which the plate coupling portion 440 (see FIG. 16) is mounted can be disposed in the cavity 10. Thus, the elevation module 400 can adjust the height of the first plate P1 provided in the cavity 10.

For this, a motor connection hole can be defined so that a portion of the elevation module 400 disposed outside the cavity 10 and a remaining portion of the elevation module 400 disposed inside the cavity 10 are not disconnected.

Next, a structure of the elevation module 400 will be described in detail.

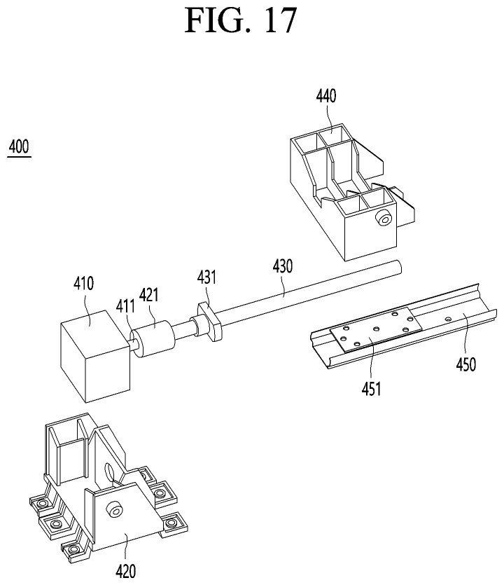

FIG. 16 is a perspective view of the elevation module provided in the cooking appliance according to an embodiment of the present disclosure. FIG. 17 is an exploded view of the elevation module provided in the cooking appliance according to an embodiment of the present disclosure.

Referring to FIGS. 16 to 17, the elevation module 400 can include some or all of a motor 410, a motor connection member 411, a motor fixing portion 420, a motor fixing member 421, a screw 430, a nut 431, a plate coupling portion 440, a rail 450, and a moving member 451.

The motor 410 can be a stepping motor. The stepping motor can be a motor that rotates at a constant angle based on a pulse signal. The motor 410 can be disposed on the top surface of the intermediate portion 11-2 of the housing. The motor 410 can include a motor connection member 411 to be connected to the motor fixing member 420.

The motor fixing portion 420 can fix the motor 410. The motor fixing portion 420 can be provided in a shape in which at least a portion of the motor 410 is seated. The motor 410 can be mounted on the motor fixing portion 420 in such a manner, in which at least a portion of the motor connection member 411 protrudes out of the motor fixing portion 420. The motor fixing portion 420 can be fixed to the rear portion 11-3 of the housing 11.

The motor fixing member 421 can fix the motor 410 or the motor fixing portion 420 on the top surface of the cavity 10. Specifically, the motor 410 can be seated on the motor fixing portion 420, and the motor connection member 411 can protrude out of the motor fixing portion 420 and be disposed to pass through the motor connection hole. Thus, at least a portion of the motor connection member 411 can protrude from the top surface of the cavity 10. The motor fixing member 421 can be coupled to the motor connection member 411 protruding from the top surface of the cavity 10 to fix the motor 410 and the motor fixing portion 420 to the top surface of the intermediate portion 11-2 of the housing 11.

The screw 430 can be connected to the motor 410 to rotate according to the rotation of the motor 410. The screw 430 can rotate in a clockwise or counterclockwise direction at a certain angle according to the rotation of the motor 410. The screw 430 can have a screw shape having a spiral groove.

The nut 431 can be provided on an outer circumferential surface of the screw 430. The nut 431 can move by a certain length as the screw 430 rotates.

The plate coupling portion 440 can be coupled to the first plate P1. The first plate P1 can be coupled to the elevation module 400 between the nut 431 moving along the outer circumferential surface of the screw 430 and the plate coupling portion 440. Thus, the first plate P1 can move by a length that the nut 431 moves according to the rotation of the screw 430.

The rail 450 can be provided to allow the first plate P1 to move stably. The rail 450 can be provided on the rear surface of the cavity 10. In addition, the rail 450 can be provided with the moving member 451 coupled to the plate coupling portion 440. The movable member 451 can be slid on the rail 450, and thus, the plate coupling portion 440 coupled to the movable member 451 can move on the rail 450. As the plate coupling portion 440 moves, the first plate P1 can also move.

In summary, the elevation module 400 can move the first plate P1 in the vertical direction within the cavity 10. Thus, the electrode-type RF heating efficiency can be maximized by adjusting the distance between the first plate P1 and the second plate P2.

In FIGS. 16 and 17, the plate coupling portion 440 can be coupled to the first plate P1, but depending on the embodiment, the plate coupling portion 440 can be coupled to the second plate P2 to adjust the height of the second plate P2.

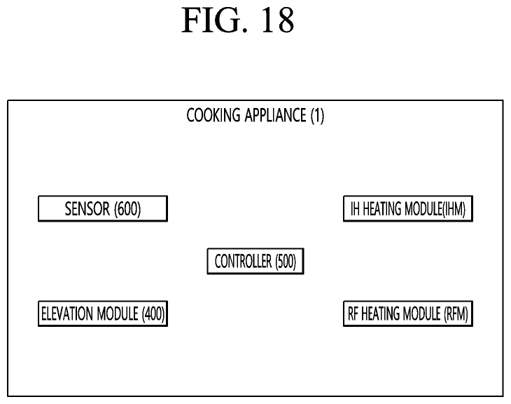

In addition, the cooking appliance 1 including the elevation module 400 according to an embodiment of the present disclosure can further include a controller 500 and a sensor 600 to automatically adjust the height of the first plate P1. In relation to this, it will be described in detail with reference to FIG. 18.

FIG. 18 is a control block diagram of the cooking appliance according to an embodiment of the present disclosure.

Referring to FIG. 18, the cooking appliance 1 can include some or all of an IH heating module IHM, an RF heating module RFM, an elevation module 400, a controller 500, and a sensor 600.

The IH heating module IHM can be a module for providing the induction heating including the working coil portion 200. The RF heating module RFM can be a module for providing the electrode-type RF heating including the RF generator 200 and the electrodes.

The controller 500 can control an overall operation of the cooking appliance 1. For example, the controller 500 can control the IH heating module IHM to provide the induction heating and adjust an intensity of the induction heating. In addition, the controller 500 can control the RF heating module RFM to provide the electrode-type RF heating and adjust the intensity of the electrode-type RF heating.

The sensor 600 can sense a height of the object 300 to be heated, which is disposed on the second plate P2. The sensor 600 can sense the height of the object 300 to be heated using various sensors such as an infrared sensor or an optical sensor.

The controller 500 can control the elevation module 400 so that the height of the first plate P1 is adjusted in a range in which the distance between the plate P1 and the second plate P2 is greater than the height of the object 300 to be heated 300, based on the height of the object 300 to be heated sensed by the sensor 600.

Thus, the distance between the first plate P1 and the second plate P2 is automatically adjusted in a range in which an upper end of the object 300 to be heated is not in contact with the first plate P1 to maximize the electrode-type RF heating efficiency, and thus, there can be a convenience advantage in that the user's intervention in the cooking process is minimized.

The cooking appliance 1 according to an embodiment of the present disclosure can provide heating optimized for sous vide cooking. The sous vide is a cooking method in which food packaged in an airtight plastic bag is heated in water for a long time.

The object 300 to be heated can be heated while sealed in a plastic bag and submerged in a dielectric. An example of the dielectric is water.

Due to the characteristics of electrode-type RF heating, when the dielectric is disposed between the electrodes, the intensity of the magnetic fields generated between the electrodes can be stronger than when the dielectric is not disposed.

When the object 300 to be heated is heated while immersed in the dielectric such as water, the dielectric can be disposed between the first plate P1 and the second plate P2, which serve as the electrodes, and thus, the intensity of the magnetic field that heats the object 300 to be heated can increase to improve the heating efficiency.

In addition, as the dielectric is disposed around the object 300 to be heated, the intensity of the electric fields in all areas of the object 300 to be heated can be the same regardless of the shape of the object 300 to be heated to enable the uniform heating.

That is, the cooking appliance 1 according to an embodiment of the present disclosure can provide the electrode-type RF heating method to improve the heating efficiency during the sous vide cooking and reduce the cooking time, thereby uniformly heating the object 300 to be heated.

In addition, the cooking appliance 1 according to an embodiment of the present disclosure can also provide the induction heating to more reduce the cooking time for dishes using water or soup dishes.

The cooking appliance 1 according to an embodiment of the present disclosure can provide the electrode-type RF heating method and the induction heating method, but it is reasonable that the heating method provided by the cooking appliance 1 is not limited thereto.

For example, the cooking appliance 1 can further include a convection module that supplies convection heat for heating the object 300 to be heated to the cavity 10 through one side of the cavity 10.

As described above, the cooking appliance 1 according to an embodiment of the present disclosure can heat the object 300 to be heated using the various heating methods, including the electrode-type RF heating method and the induction heating method.

According to the embodiment of the present disclosure, the structure of the cooking appliance that provides the plurality of heating sources can be simplified. Specifically, since the plate on which the object to be heated is disposed simultaneously serves as the electrode used in the electrode-type RF heating method and the intermediate heating element that transfers the heat to the container in the induction heating method, the structure of the cooking appliance can be simplified.

According to the embodiment of the present disclosure, the object to be heated can be uniformly heated from the inside using the electrode-type RF heating method, and the object to be heated can be heated from the lower portion thereof using the induction heating method to reduce the cooking time and save the energy.

According to the embodiment of the present disclosure, even when the position of the plate on which the object to be heated is disposed is adjusted to maximize the heating efficiency of the electrode-type RF heating method, the heating efficiency of the induction heating method may not be deteriorated to maximize the heating efficiency of the entire cooking appliance.

The above description is merely illustrative of the technical idea of the present disclosure, and various modifications and changes can be made thereto by those skilled in the art without departing from the essential characteristics of the present disclosure.

Therefore, the embodiments of the present disclosure are not intended to limit the technical spirit of the present disclosure but to illustrate the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

What is claimed is:

1. A cooking appliance comprising:
a housing including a cavity;
a door connected to the housing and configured to open and close the cavity;
a radio frequency (RF) generator configured to generate RF power for generating electric fields in the cavity;
an RF matcher configured to match an impedance of the RF power with a load of the cavity; and
a working coil configured to emit magnetic fields toward the cavity.

2. The cooking appliance according to claim 1, wherein a bottom surface of the cavity includes at least one hole configured to allow the magnetic fields to pass through the housing and enter the cavity.

3. The cooking appliance according to claim 1, further comprising:
a first plate; and
a second plate disposed opposite to the first plate,
wherein the first and second plates are configured to heat an object based on the electric fields or the magnetic fields, and
wherein the second plate is in contact with opposite side surfaces of the cavity.

4. The cooking appliance according to claim 3, wherein the second plate is disposed between the first plate and the bottom surface of the cavity.

5. The cooking appliance according to claim 3, wherein the first and second plates are configured to generate the electric fields based on the RF power.

6. The cooking appliance according to claim 3, wherein the second plate is made of a material configured to be heated by the magnetic fields emitted by the working coil.

7. The cooking appliance according to claim 3, further comprising a support member configured to support at least one of the first or second plate at different heights.

8. The cooking appliance according to claim 3, further comprising an elevation part configured to move at least one of the first plate or the second plate in an ascending direction or a descending direction.

9. The cooking appliance according to claim 8, further comprising a sensor configured to sense a height of the object to be heated,
wherein at least one of the first plate or the second plate is configured to move in a vertical direction based on the height of the object to be heated.

10. The cooking appliance according to claim 3, wherein the working coil is disposed between the second plate and the bottom surface of the cavity.

11. The cooking appliance according to claim 3, wherein the first plate includes an anode member, and the second plate includes a cathode member.

12. The cooking appliance according to claim 1, further comprising a convection part configured to supply convection heat to the cavity through one surface of the cavity.

13. A cooking applicant comprising:
a first plate;
a second plate; and
a radio frequency (RF) generator configured to generate RF power for generating electric fields, the RF generator being electrically connected to the first and second plates,
wherein a height of at least one of the first plate and the second plate is adjustable.

14. The cooking appliance according to claim 13, wherein the first plate includes an anode electrode and the second plate includes a cathode electrode.

15. The cooking appliance according to claim 13, further comprising a working coil configured to emit magnetic fields for heating an object.

16. The cooking appliance according to claim 15, wherein the second plate includes at least one hole configured to pass the magnetic fields through the second plate.

17. The cooking appliance according to claim 16, wherein the at least one hole in the second plate is filled with a material configured to pass the magnetic fields therethrough.

18. The cooking appliance according to claim 13, further comprising an elevation part configured to adjust the height of the at least one of the first plate and the second plate.

19. The cooking appliance according to claim 13, further comprising:
a working coil configured to emit magnetic fields for heating an object; and
an elevation part configured to adjust the height of the at least one of the first plate and the second plate to increase a strength of the electric fields,
wherein the working coil is configured to move along with a movement of the at least one of the first plate and the second plate.

20. The cooking appliance according to claim 13, further comprising:
a working coil configured to emit magnetic fields for heating an object; and
an elevation part configured to adjust the height of the at least one of the first plate and the second plate to increase a strength of the electric fields,
wherein the working coil is configured to remain stationary while the at least one of the first plate and the second plate moves closer to the working coil.
